(19) United States
(12) Patent Application Publication
(10) Pub. No.: US 2009/0091301 A1
(43) Pub. Date: Apr. 9, 2009

(54) LOAD LOWERING REGENERATIVE ENERGY SYSTEM WITH CAPACITOR CHARGE AND DISCHARGE CIRCUIT AND METHOD OF OPERATING THE SAME

(75) Inventors: Michael D. Gandrud, Ames, IA (US); Jeff Herrin, Ankeny, IA (US)

Correspondence Address: ZARLEY LAW FIRM P.L.C., CAPITAL SQUARE, 400 LOCUST, SUITE 200, DES MOINES, IA, 50309-2350, US

(73) Assignee: Sauer-Danfoss Inc., Ames, IA (US)

(21) Appl. No.: 11/868,782

(22) Filed: Oct. 8, 2007

(51) Int. Cl. H02J 7/00

(52) U.S. Cl. 320/166

(57) ABSTRACT

An operating system for an electric motor associated with a hydraulic pump for moving a load and method of operating the same. The operating system includes a power source that is electrically connected to the electric motor wherein a capacitor charge and discharge circuit is used in association with a capacitor in order to store energy within the capacitor as the operating system is in use.

### BACKGROUND OF THE INVENTION

This invention relates to a power handling and storage system for industrial material handling trucks. More specifically, this invention relates to an operating system for an electric motor associated with a hydraulic pump for moving a load.

Industrial material handling trucks are used in many industrial facilities to move products and for loading and unloading of transportation vehicles. Additionally, the industrial material handling trucks are used for placing and removing products from shelves and for other purposes that are well known in the art.

Such trucks of the present art consume energy to steer and propel themselves about a facility, to lift and load, and for various other auxiliary purposes. Specifically, electrohydraulic systems are used in the raising and lowering of payloads in such trucks. A payload at elevation possesses a certain degree of potential energy that can theoretically be captured to charge a battery or for other useful purposes when a payload is lowered.

Prior inventions have taught electrohydraulic methods of electrically regenerating energy while lowering a load. Unfortunately, regenerative load lowering methods of the prior art have failed because the regenerative energy charged a lead acid storage battery at a more rapid rate than the battery could effectively store. Each time that a regenerative load lowering system attempted to charge a storage battery at such an excessive rate, cumulative damage occurs to the battery and only a fraction of the charging current is effectively stored.

Additionally, a battery maintains a relatively constant voltage as current is introduced into a battery during charging and as current is drawn from the battery during discharge. Thus, such applications drain or charge a battery at a rapid rate for a short period of time thus damaging the conventional batteries and thereby shortening the life time of the batteries.

Prior art references have suggested the use of capacitors that can be used to store energy; however, these references do not provide how to control the transfer of energy to the capacitors in such a way to provide efficient storage of the energy. Similarly, how energy is discharged from these capacitors is also not taught in a way to provide an efficient method of operation.

Therefore, a principal object of the present invention is to provide an operating system for an electric motor that minimizes loss of energy in the system.

Yet another object of the present invention is to utilize a circuit for introducing current to a regenerative energy storage capacitor to improve efficiency therein.

These and other objects, features, or advantages of the present invention will become apparent from the specification and claims.

### BRIEF SUMMARY OF THE INVENTION

An operating system for an electric motor associated with a hydraulic pump for moving a load. The operating system includes a power source that is electrically connected to the electric motor and a capacitor charge and discharge circuit electrically connected to the power source. A capacitor is electrically connected to the capacitor charge and discharge circuits such that the capacitor charge and discharge circuit introduces current in the capacitor at a varying voltage as the capacitor is being discharged.

### BRIEF DESCRIPTION OF THE DRAWINGS

The Figure is a schematic diagram of an operating system for an electric motor.

### DETAILED DESCRIPTION OF THE PREFERRED EMBODIMENT

The figures show a schematic diagram of the operating system 10 of an industrial material handling truck 12. Though shown used in association with an industrial material handling truck the system could be used with any device that uses an electrohydraulic power source.

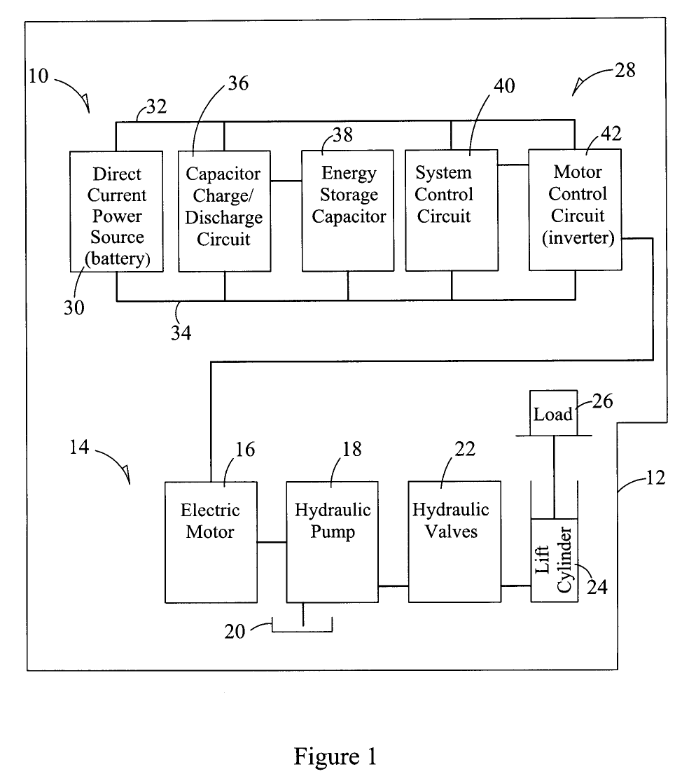

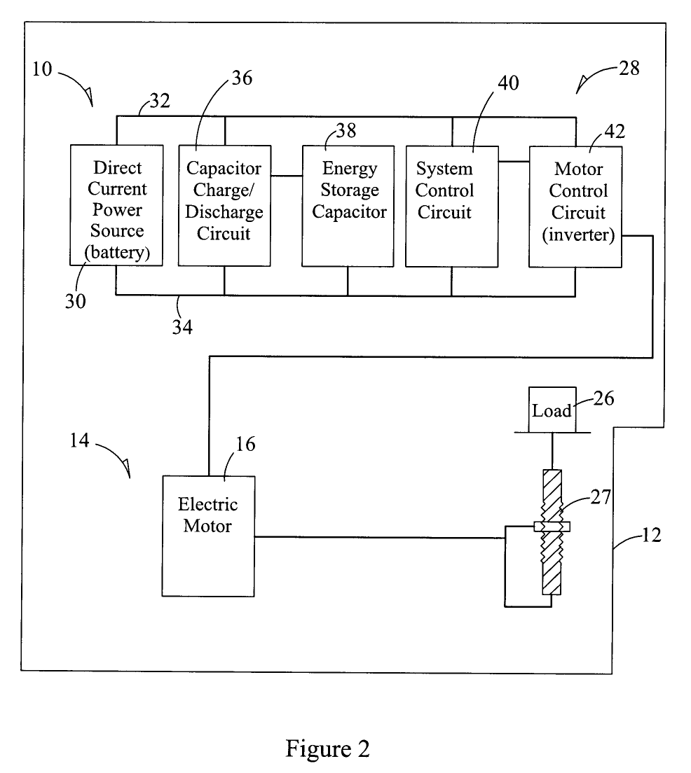

The lift system 14 of the truck 12 contains an electrohydraulic motor having an electric power means 16 such as an electric motor that is connected to a hydraulic pump 18. Hydraulic pump 18 is in fluid communication with a fluid reservoir 20 to provide fluid to a hydraulic valve 22 to a lift cylinder 24 in order to lift a load 26. Though in a preferred embodiment hydraulic valves 22 are used, in another embodiment the hydraulic pump may be in direct fluid flow communication with the lift cylinder 24 without the use of the hydraulic valves 22. Similarly, in another embodiment a threaded screw apparatus 27 (FIG. 2) could be used to lift load 26 without falling outside the scope of this disclosure.

The operating system 10 has a control system 28 that utilizes a power source 30 that in one embodiment is a direct current power source. Additionally, in a preferred embodiment the power source 30 is a battery. The power source 30 is electrically connected to the other components of the system via positive DC bus wires 32 and negative DC bus wires 34.

Other components of the control system 28 include a capacitor charge and discharge circuit 36 that is electrically connected to the power source 30 and to a capacitor 38. Specifically, capacitor 38 is able to store energy therein to effectively regenerate energy through the system. The control system 28 additionally has a system control circuit 40 and a motor control circuit 42 that are electrically connected with the other components of the control system 28. In a preferred embodiment the motor control circuit 42 is an inverter. Specifically, the motor control circuit 42 is electrically connected to the electric power means 16 to control the electrohydraulic system 14.

In operation when the lift cylinder 24 is actuated to lower a load 26 the capacitor charge and discharge circuit 36 introduces a varying voltage to the capacitor 38 as the capacitor 38 is charged. Similarly, current is drawn from the capacitor 38 at a varying voltage as the capacitor is discharged. Because the capacitor changes voltage significantly during charge and discharge the varying input from the capacitor charge and discharge circuit 36 facilitates and creates a more efficient storage of energy within the capacitor.

Persons skilled in the art will realize that any suitable type of capacitor could be used in the present invention including standard capacitors, electrolytic capacitors, super capacitors, electrochemical capacitors are all specifically contemplated in the present invention. The present invention additionally contemplates that a plurality of capacitors may be used, arranged in series, parallel, or otherwise. While the example of lifting and lowering a payload is taught as a means of using the present invention, persons skilled in the are will realize that the present invention applies in a like manner to any system that develops regenerative energy whatever the source of the regenerative energy including the deceleration and subsequent acceleration of any load or truck, a change in elevation of a load or truck, or any other source of regenerative energy within an industrial truck.

Specifically, the energy stored in a capacitor follows a formula of E=0.5*C*V̂2 wherein E is the total energy stored in joules, C is the capacitance in farads and V is the voltage across the terminals of the capacitors. As a result of this changing voltage characteristic the capacitor charge and discharge circuit 36 is adapted of being capable of introducing current into the capacitor at a varying voltage as the capacitor is charged and similarly drawing current from the capacitor at a varying voltage as the capacitor is discharged. As a result the capacitor is able to store energy more rapidly than a battery and the capacitor charge and discharge circuit 36 ensures proper functioning to create maximum storage and efficiency within the control system 28. Thus, at the very least all of the stated objectives have been met.

It will be appreciated by those skilled in the art that other various modifications could be made to the device without departing from the spirit in scope of this invention. All such modifications and changes fall within the scope of the claims and are intended to be covered thereby.

What is claimed is:

1. A method of operating an electric motor associated with a hydraulic pump for moving a load comprising:
providing a power source electrically connected to the electric motor;
providing a capacitor charge and discharge circuit electrically connected to the power source;
providing a capacitor electrically connected to the capacitor charge and discharge circuit for storing energy therein;
drawing current from the capacitor at a varying voltage as the capacitor is discharged with the capacitor charge and discharge circuit.

2. The method of claim 1 further comprising the step of providing a system control circuit electrically connected to the power source.

3. The method of claim 2 further comprising the step of providing a motor control circuit electrically connected to the electric motor.

4. The method of claim 3 wherein the motor control circuit is an inverter.

5. The method of claim 1 wherein the power source is a direct current power source.

6. The method of claim 1 further comprising the step of introducing current into the capacitor at a varying voltage as the capacitor is charged with the capacitor charge and discharge circuit.
